(19) United States
(12) Patent Application Publication
(10) Pub. No.: US 2008/0125099 A1
(43) Pub. Date: May 29, 2008

(54) SYSTEM AND METHOD FOR SHARING ADDRESS BOOK ENTRY BETWEEN WIRELESS DEVICES

(76) Inventors: Lyndell L. BROWN, San Diego, CA (US); Mazen CHMAYTELLI, San Diego, CA (US); Christophe BERNARD, San Diego, CA (US)

Correspondence Address: QUALCOMM INCORPORATED, 5775 MOREHOUSE DR., SAN DIEGO, CA, 92121, US

(21) Appl. No.: 11/563,195

(22) Filed: Nov. 25, 2006

(51) Int. Cl. H04Q 7/22; H04Q 7/20; H04B 1/38

(52) U.S. Cl. 455/414.2; 455/466; 455/557

(57) ABSTRACT

Apparatus and methods provide for transmitting a contact record including a telephone number associated with a contact to another wireless device. The contact may be transmitted during a voice telephone call, or following a voice telephone call.

### FIELD OF THE INVENTION

The present invention relates generally to wireless communication, and more particularly to exchanging information between wireless devices.

### BACKGROUND OF THE INVENTION

FIG. 1 is an illustration of a wireless communication system 100. The system 100 includes a plurality of wireless devices 110, such as cellular telephones, and a plurality of base stations (BTS) 120 which are arranged to provide coverage over a geographic area. Each wireless device 110 is typically in communication with a just one of the BTSs 120. However, there may be some situations where a wireless device 110 is in communication with multiple BTSs 120. Such situations may occur when the wireless device 110 is transiting between the coverage areas of two BTSs 120 and the wireless network is using a soft hand-off technique for controlling the transition between two different BTSs 120. Another example of such a situation may include calculating a geographic location of the wireless device 110 based upon the location of two or more BTSs 120.

The system 100 also includes a mobile switching center (MSC) 130. The MSC 130 is in communication with each of the BTSs 120, and with the carrier network 140 of the wireless carrier operating the BTSs 120 and the MSC 130. The carrier network 140 may include one or more routers 150, for coupling the carrier network 140 to other networks (not illustrated). Examples of the other networks may be other voice and data networks, including for example, another wireless carrier's network, a land line carrier's network, and/or a data network, such as the Internet. The system 100 provides voice and data based services to the wireless devices 110. Accordingly, the wireless network 240 provides the capability for routing voice and data between the wireless devices 110.

FIG. 2 is a more detailed illustration of the wireless device 110. The wireless device 110 includes a radio transceiver 210 for wirelessly communicating with one or more BTSs 120 (FIG. 1) of the wireless communication system 100. The radio transceiver 210 is coupled to a bus 250. The wireless device 210 also includes a user interface 220, which is also coupled to the bus 250. Typically, the user interface 220 includes a display, a small keyboard, a microphone, and a speaker. The wireless device 110 also includes a memory 230, which is also coupled to the bus 250. The memory 230 may store code for supporting an application programming interface (API) 231.

The contents of the memory 230 may also include one or more built-in applications, and memory space for receiving one or more downloadable applications. One common built-in application is an address book application 232. The address book application 232 is used to manage a database containing a plurality of contact records. Each contact record may comprise a name and an associated telephone number of a contact. In many phones the address book application 232 is capable of managing several hundred contact records.

One problem associated with the address book application 232 is that the address book application 232 is intended for use only by the user of the wireless device 110. Thus, if during a conversation the party to whom the user of the wireless device 100 wishes to know the telephone number of a contact stored in the user's wireless device, the user would have to manually retrieve the contact record associated with the contact and verbally communicate the telephone number to the other party. Accordingly, there is a need and desire for methods and apparatuses to permit forwarding of contact information from one wireless device to another device.

### SUMMARY OF THE INVENTION

The disclosed embodiments provide apparatus and methods for transmitting a contact record including a telephone number associated with a contact to another wireless device. In one aspect, the invention includes a method for sending contact information from a local device to a wireless device, comprising: establishing a voice telephone call with said wireless device, selecting a contact record, and transmitting said contact record to said wireless device.

In another aspect, the invention includes a method for receiving contact information on a local device from a wireless device, comprising: establishing a voice telephone call with said wireless device, receiving a contact record from said wireless device, and storing said contact record in said local device.

In yet another aspect, the invention includes a wireless device comprising: a bus, a radio transceiver, coupled to said bus, a user interface, coupled to said bus, a memory, coupled to said bus, and an ASIC, coupled to said bus, said ASIC configured to control said radio transceiver, user interface, and memory; wherein said memory stores an address book application and said address book application is configured to manage a database of contact records and said address book application is configured to, after a user of the wireless device has established a voice telephone call with an another wireless device: permit the user of the wireless device to select a contact record from said database; and transmit said contact record to said another wireless device.

In another aspect, the invention includes a computer readable medium for storing instructions executable by a local device thereon, said instructions comprising: instructions for selecting a contact record of said local device; and instructions for transmitting said contact record to said wireless device.

In yet another aspect, the invention includes a computer readable medium for storing instructions executable by a local device thereon, said instructions comprising: instructions for receiving a contact record of said local device from said wireless device; and instructions for storing said contact record in said local device.

In another aspect, the invention includes a wireless device, comprising: a bus means; a radio transceiver means, coupled to said bus means; a user interface means, coupled to said bus means; a memory means, coupled to said bus means; and an ASIC means, coupled to said bus means, said ASIC means configured to control said radio transceiver means, said user interface means, and said memory means; wherein said memory means stores an address book application means and said address book application means is configured to manage a database means of contact records and said address book application means is configured to, after a user of the wireless device has established a voice telephone call with an another wireless device: permit the user of the wireless device to select a contact record from said database means; and transmit said contact record to said another wireless device.

### BRIEF DESCRIPTION OF THE DRAWINGS

The foregoing and other advantages and features of the invention will become more apparent from the detailed description of embodiments of the invention given below with reference to the accompanying drawings in which:

FIG. 1 is a illustration of a conventional wireless communication system;

FIG. 2 is a illustration of a conventional wireless device;

FIG. 3 is an illustration of a wireless device in accordance with one embodiment of the present invention;

FIG. 4 is a flow chart illustrating a process for sending a contract; and

FIG. 5 is a flow chart illustrating a process for receiving a contact.

### DETAILED DESCRIPTION

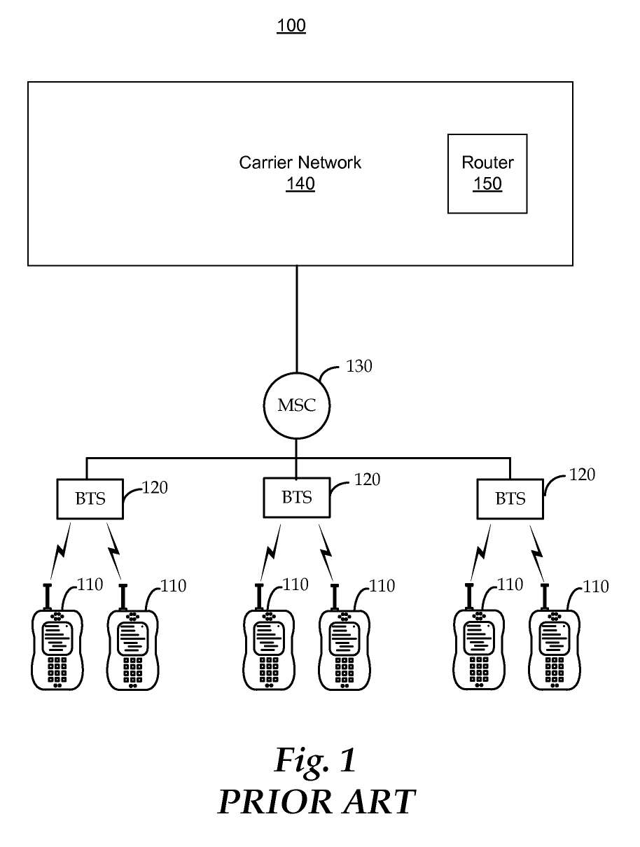

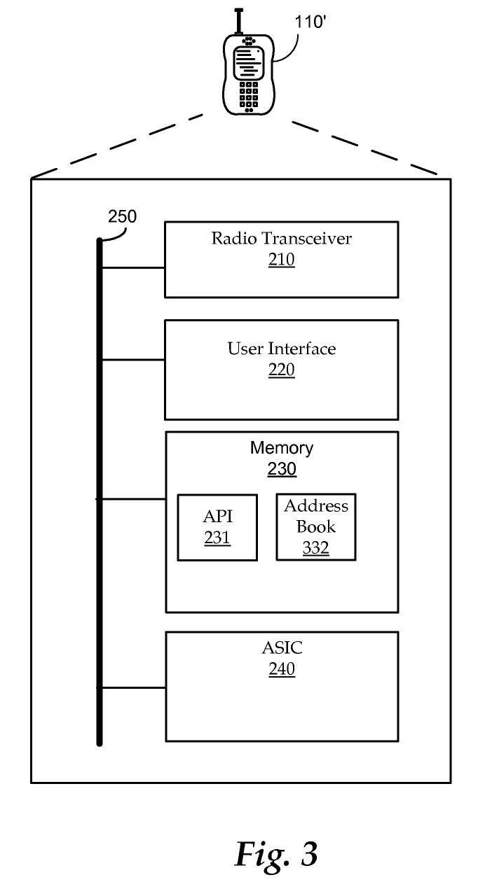

Now referring to the drawings, where like reference numerals designate like elements, there is shown in FIG. 3, a wireless device 110′ in accordance with one embodiment of the present invention. The wireless device 110′ can be substituted for the wireless device 110 (FIG. 1) in the wireless communication system 100.

The wireless device 100′ includes a radio transceiver 210 for wirelessly communicating with one or more BTSs 120 (FIG. 1) of the wireless communication system 100. The radio transceiver 210 is coupled to a bus 250.

The wireless device 210 also includes a user interface 220, which is also coupled to the bus 250. Typically, the user interface 220 includes a display, a small keyboard, a microphone, and a speaker. However, one skilled in the art will recognize that the invention can be practiced using different user interfaces. Further, in one embodiment, the user interface 220 includes software for providing a carrier configurable display interface. For example, in one embodiment, the user interface includes the UIONE® user interface from QUALCOMM® Incorporated. Such user interfaces may be configured by a carrier (or another authorized third party) such that different wireless devices have different look-and-feel. However, as the look-and-feel are supported by a same software (e.g., UIONE®), such devices are compatible with each other with respect to data exchange.

The wireless device 110 also includes a memory 230, which is coupled to the bus 250. The memory 230 may store code for supporting an application programming interface (API) 231. In one embodiment, the API is the API associated with QUALCOMM®, Inc.'s BREW® platform, however, one skilled in the art will recognize that the invention may be practiced in wireless devices which support other APIs.

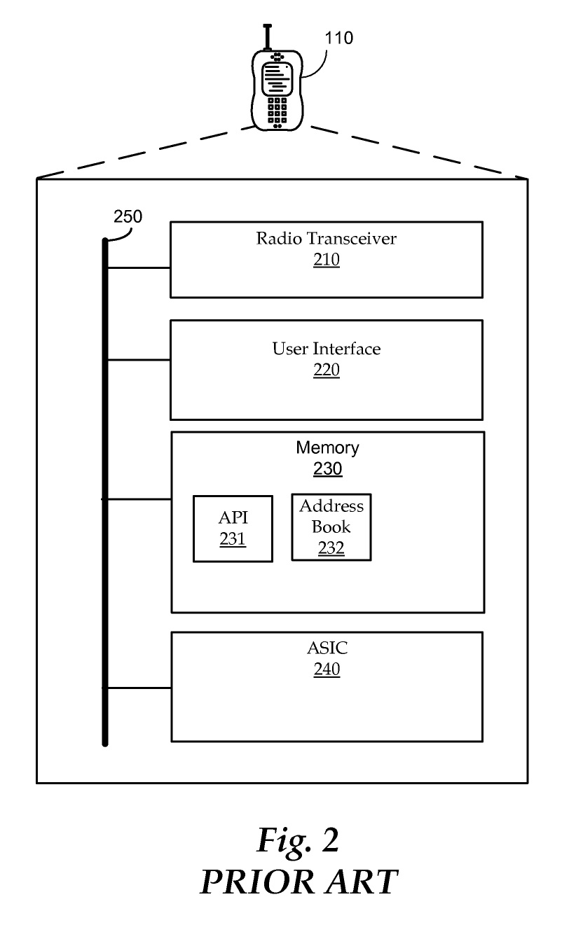

The contents of the memory 230 may also include one or more built-in applications, and memory space for receiving one or more downloadable applications. In particular, the contents of the memory 230 includes an address book application 332. The address book application 332 is similar to the address book application 232 (FIG. 2) of a conventional wireless device 110, insofar as both are used in their respective wireless devices 110′, 110 to manage the contact record database associated with the address book application. Each contact record may comprise a name and an associated telephone number of a contact. Alternatively, each contact record may comprise a name and several different associated telephone numbers of a contact. For example, the different associated telephone numbers may include telephone numbers for the contact's home phone number, work phone number, mobile phone number, fax phone number, and/or other additional phone numbers.

However, as explained in greater detail below, the address book application 332 differs from the conventional address book application 232 by supporting sharing of contact information between wireless devices. Further, as explained below, the wireless device 110′ of the invention preferably is configured such that it can share contact information with both another wireless device 110′ of the invention as well as a conventional wireless device 110.

The wireless device 110′ also includes an application specific integrated circuit (ASIC) 240, which controls the radio transceiver 210, user interface 220, and memory 230, via the bus 250.

One skilled in the art would understand that the architecture of the wireless device 110′ can be varied without departing from the scope of the invention. For example, some potential variations include having multiple radio transceivers 210, have multiple memory unit 230, include, for example, different types of memory units such as a DRAM base memory unit and a non-volatile memory unit, for example, a FLASH, EPROM, EEPROM, or ROM memory unit. In some embodiments, at least part of the memory 230 may be embodied on the ASIC 240. Further, the ASIC 240 may be a plurality of ASICs or some combination of a non-ASIC chip and one or more ASICS.

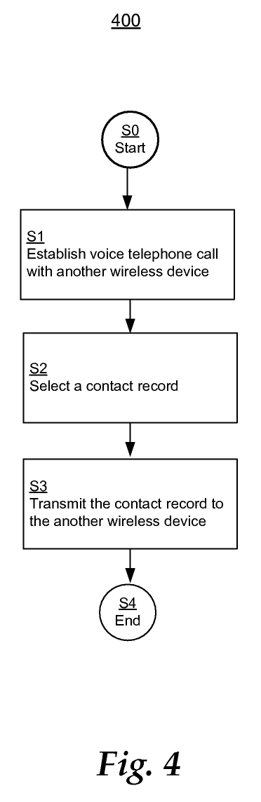

FIG. 4 is a flow chart illustrating a process 400 for sending a contact record from one wireless device 110′ to another wireless device 110 or 110′. The process 400 starts at step S0 by proceeding to step S1.

At step S1, a voice telephone call is established with another wireless device 110 or 110′. The voice telephone call can be established by placing a call from the one wireless device 110′ or by receiving a call placed by another wireless device 110 or 110′. Once the telephone call has been established, the process 400 proceeds to step S2.

At step S2, the address book application 332 on the one wireless device 110′ is used to select a contact record. Once the contact record has been selected, the process 400 proceeds to step S3.

At step S3, the address book application causes the selected contact record to be sent to the another wireless device 110 or 110′. In one embodiment, the contact record is transmitted as a text message, for example, a short message service (SMS) message. However, one of ordinary skill in the art will recognize that other types of messaging services can be used to transmit the contact record.

In one embodiment, when the another wireless device is a wireless device 110′, the address book application 332 is configured to respond to incoming messages during the voice telephone call. Accordingly, the contact record can be transmitted while the voice telephone call established at step S1 is still in session. However, the present invention can also be utilized when the another wireless device is a conventional wireless device 110. In such circumstances, the contact record can be transmitted after the voice telephone call established at step S1 is terminated, as the address book 232 of the conventional wireless device 110 would not be responsive to the message transmitting the contact record during the voice phone call. In one embodiment, the transmission of the contact record is started after the wireless device 110′ enters into a stand-by mode following termination of the voice telephone call established in step S1.

In one embodiment, the decision regarding whether to send the contact record during or after the voice telephone call can be set via a user preference in the address book 332 of the one wireless device. In another embodiment, the decision is dynamically configured. For example, an inquiry can be sent as a text message (e.g., SMS message) from the one wireless device 110′ to the another wireless device. If the another wireless device is a wireless device 110′, the address book application 332 on the another wireless device will receive the inquiry message and respond, indicating to the sending wireless device that the another wireless device is a wireless device 110′, thereby permitting the contact record to be sent during the voice telephone call. If no response is received, the one wireless device can conclude that the another wireless device is a wireless device 110, and thereby cause the sending wireless device 110′ to send the wireless device following termination of the voice telephone call.

Following transmission of the contact record to the another wireless device, the process 400 terminates at step S4.

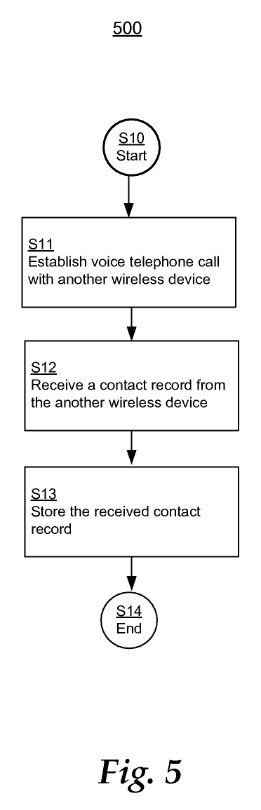

FIG. 5 is a flow chart illustrating a process 500 for receiving a contact record on one wireless device 110 or 110′ from another wireless device 110′. The process 500 starts at step S10 by proceeding to step S11.

At step S11, a voice telephone call is established with another wireless device 110′. The voice telephone call can be established by placing a call from the one wireless device 110 or 110′, or by receiving a call placed by another wireless device 110′. Once the telephone call has been established, the process 500 proceeds to step S12.

At step S12, a contact record is received from the another wireless device 110′. The contact record is typically received as a form of text messaging, such as an SMS message. In one embodiment, if the one wireless device is a conventional wireless device 110, the contact record is received following termination of the voice phone call established at step S11. In another embodiment, if the one wireless device is a wireless device 110′, the address book application 332 is configured to respond to a message containing the contact record during the voice phone call established at step S11, and the contact record can be sent during the voice call established at step S11. Following step S12, the process 500 continues at step S13. However in one embodiment (not illustrated), the process ends at step S14 following step S12.

In one embodiment, the address book 332 responds to an inquiry message sent by the another wireless device 110′ by recognizing the inquiry message and sending a text message to the another wireless device 110′ to indicate that the one wireless device is a wireless device 110′.

At step S13, the received contact information is stored in the database of the address book 332. Following step S13, the process 500 stops at step S14.

While the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

What is claimed as new and desired to be protected by Letters Patent of the United States is:

1. A method for sending contact information from a local device to a wireless device, comprising:
establishing a voice telephone call with said wireless device;
selecting a contact record; and
transmitting said contact record to said wireless device.

2. The method of claim 1, wherein said step of establishing a voice telephone call comprises initiating an outgoing voice telephone call to said wireless device.

3. The method of claim 1, wherein said step of establishing a voice telephone call comprises answering an incoming voice telephone call initiated by said wireless device.

4. The method of claim 1, wherein said step of selecting comprises:
opening an address book database of said local device, said address book database comprising a plurality of contact records; and
selecting one of said plurality of contact records as said contact record.

5. The method of claim 1, wherein said step of transmitting comprises sending information of said contact record to said wireless device via a data transmission.

6. The method of claim 5, wherein said data transmission is a form of text messaging.

7. The method of claim 5, wherein said data transmission comprises at least one short message service (SMS) message.

8. The method of claim 1, wherein said act of transmitting occurs while said voice telephone call is established.

9. The method of claim 1, further comprising:
terminating said voice telephone call;
wherein said act of transmitting occurs after said act of terminating.

10. The method of claim 9, further comprising:
after said terminating, entering into a stand-by mode by said local device;
wherein said act of transmitting occurs after said local device enters into said stand-by mode.

11. A method for receiving contact information on a local device from a wireless device, comprising:
establishing a voice telephone call with said wireless device;
receiving a contact record from said wireless device; and
storing said contact record in said local device.

12. The method of claim 11, wherein said step of establishing a voice telephone call comprises initiating an outgoing voice telephone call to said wireless device.

13. The method of claim 11, wherein said step of establishing a voice telephone call comprises answering an incoming voice telephone initiated by said wireless device.

14. The method of claim 11, wherein said step of storing comprises:
opening an address book database of said local device, said address book database for storing a plurality of contact records; and
storing said contact record in said address book database.

15. The method of 11, where said step of receiving comprises sending information of said contract record to said wireless device via a data transmission.

16. The method of claim 15, wherein said data transmission is in a form of text messaging.

17. The method of claim 15, wherein said data transmission comprises at least one short message service (SMS) message.

18. The method of claim 11, wherein the act of receiving occurs while said voice telephone call is established.

19. The method of claim 11, further comprising:
terminating said voice telephone call;
wherein said act of receiving occurs after said act of terminating.

20. The method of claim 19, comprising:
after said terminating, entering into a stand-by mode by said local device;
wherein said act of receiving occurs after said local device enters into said stand-by mode.

21. A wireless device, comprising:
a bus;
a radio transceiver, coupled to said bus;
a user interface, coupled to said bus;
a memory, coupled to said bus; and
an ASIC, coupled to said bus, said ASIC configured to control said radio transceiver, user interface, and memory;
wherein said memory stores an address book application and said address book application is configured to manage a database of contact records and said address book application is configured to, after a user of the wireless device has established a voice telephone call with an another wireless device:
permit the user of the wireless device to select a contact record from said database; and
transmit said contact record to said another wireless device.

22. The wireless device of claim 21, wherein said address book application is configured to transmit said contact record using a text message.

23. The wireless device of claim 21, wherein said address book application is configured to transmit said contact record using a short message service (SMS) message.

24. The wireless device of claim 21, wherein said address book application is configured to transmit said contact record during said voice telephone call.

25. The wireless device of claim 21, wherein said address book application is configured to transmit said contact record after termination of said voice telephone call.

26. A computer readable medium for storing instructions executable by a local device thereon, said instructions comprising:
instructions for selecting a contact record of said local device; and
instructions for transmitting said contact record to said wireless device.

27. A computer readable medium for storing instructions executable by a local device thereon, said instructions comprising:
instructions for receiving a contact record of said local device from said wireless device; and
instructions for storing said contact record in said local device.

28. A wireless device, comprising:
a bus means;
a radio transceiver means, coupled to said bus means;
a user interface means, coupled to said bus means;
a memory means, coupled to said bus means; and
an ASIC means, coupled to said bus means, said ASIC means configured to control said radio transceiver means, said user interface means, and said memory means;
wherein said memory means stores an address book application means and said address book application means is configured to manage a database means of contact records and said address book application means is configured to, after a user of the wireless device has established a voice telephone call with an another wireless device:
permit the user of the wireless device to select a contact record from said database means; and
transmit said contact record to said another wireless device.
